(19) United States
(12) Patent Application Publication
(10) Pub. No.: US 2002/0172859 A1
(43) Pub. Date: Nov. 21, 2002

(54) Polymer electrolyte precursor having improved impedence

(76) Inventors: Kwon-Sun Roh, Chungcheongnam-do (KR); Jong-Hyuk Choi, Seoul (KR); Dong-Joon Ihm, Seoul (KR); Jon-Ha Lee, Chungcheongnam-do (KR)

Correspondence Address: David A. Einhorn, Esq., Anderson Kill & Olick, P.C., 1251 Avenue of the Americas, New York, NY, 10020, US

(21) Appl. No.: 10/143,259

(22) Filed: May 9, 2002

(30) Foreign Application Priority Data
May 16, 2001 (KR) 2001-0026757

(51) Int. Cl. H01M 10/40

(52) U.S. Cl. 429/189; 429/316; 429/307

(57) ABSTRACT

A polymer electrolyte precursor comprising a VdF-HFP copolymer, a lithium and a plasticizer is used for the preparation of a bellcore-type polymer battery having improved impedence, low-temperature characteristics, cycle life and self-discharge properties.

### FIELD OF THE INVENTION

The present invention relates to a polymer electrolyte precursor useful for a bellcore-type polymer battery, which is capable of providing improved impedence, low-temperature characteristics, cycle life and self-discharge properties; a process of preparing said polymer electrolyte precursor; and a bellcore-type polymer battery comprising said polymer electrolyte precursor.

### BACKGROUND OF THE INVENTION

Lithium secondary batteries have a common structural feature that includes a cathode, an anode, an organic electrolyte and a lithium ion-permeable separator disposed between the electrodes. The electrical energy is generated by redox reactions occurring on the electrodes. The conventional lithium secondary batteries have the problem of internal short-circuiting due to the formation of lithium dendrites, particularly when an organic electrolyte solution is employed.

In order to overcome the dendrite problem, a lithium polymer battery where a separator interposed between a cathode and an anode is of a polymeric material membrane which acts as an ion conductive intermediate of the electrodes, i.e., an electrolyte, has been proposed. Such a polymer electrolyte provides little or no continuous free path of low viscosity fluid in which the lithium dendrites may propagate.

The polymer electrolyte, however, generally exhibits lower ionic conductivity than a range of effective ionic conductivity, i.e., over about 10⁻⁵ to 10⁻³ S/cm.

Accordingly, in terms of improved ionic conductivity, recent battery researches have concentrated on a technique that a portion of plasticizer from a polymeric matrix composition comprising a polymer and a plasticizer is removed by extraction, and is replaced with a lithium salt electrolyte solution by imbibition. A rechargeable polymer battery adopting such technique is referred as to “a bellcore-type polymer battery”, a tribute to the development first made by Bell Communications Research Inc.

For example, U.S. Pat. Nos. 5,460,904, 5,456,000 and 5,418,091 disclose a separator membrane comprising a copolymer of vinylidene fluoride with 8 to 25% by weight hexafluoropropylene and a plasticizer, substantially being devoid of electrolytic salt and in a preconditioned state conducive to absorption of electrolytic solution by removal of a portion of the plasticizer.

However, the above bellcore-type polymer battery still exhibits limited ionic conductivity due to the high impedence of the separator, and, thus, there has continued to exist a need to develop a lower impedence polymer electrolyte precursor useful for a bellcore-type polymer battery.

### SUMMARY OF THE INVENTION

Accordingly, it is an object of the present invention to provide a polymer electrolyte precursor for a bellcore-type polymer battery having improved impedence.

It is another object of the present invention to provide a process of preparing said polymer electrolyte precursor.

It is a further object of the present invention to provide a polymer battery comprising said polymer electrolyte precursor.

In accordance with one aspect of the present invention, there is provided a polymer electrolyte precursor for a polymer battery, which comprises a vinylidene fluoride(VdF)-hexafluoropropylene(HFP) copolymer having an HFP content of 0.1 to 8% by weight, a lithium salt and a plasticizer.

### BRIEF DESCRIPTION OF THE DRAWINGS

The above and other objects and features of the present invention will become apparent from the following description of the invention, when taken in conjunction with the accompanying drawings, which respectively show:

FIG. 1: impedence values(mOhm) at 1 KHz of the lithium polymer batteries obtained in Examples and Comparative Example;

FIG. 2: variations of regular discharge capacity(%) of the lithium polymer batteries obtained in Examples and Comparative Example as a function of discharge rate(C);

FIG. 3: low-temperature property values(capacity at −10° C./capacity at room temperature, %) at 1C discharge rate of the lithium polymer batteries obtained in Examples and Comparative Example; and

FIG. 4: variations of regular discharge capacity(%) of the lithium polymer batteries obtained in Examples and Comparative Example as a function of the number of cycles.

### DETAILED DESCRIPTION OF THE INVENTION

The polymer electrolyte precursor for a polymer battery in accordance with the present invention comprises a VdF-HFP copolymer, a lithium salt and a plasticizer. It is noted that while the hitherto polymer electrolyte precursor for a bellcore-type polymer battery is substantially devoid of electrolytic lithium salt, the inventive electrolyte precursor comprises a specified amount of lithium salt which is distributed evenly therein to have a reduced impedence.

In accordance with another aspect of the present invention, there is provided a process of preparing a polymer electrolyte precursor which comprises the steps of coating and drying a composition comprising a VdF-HFP copolymer, a lithium salt, a plasticizer and an organic solvent on a substrate, and then removing a portion of the plasticizer from the coating.

The coating substrate may be an electrode or any supporting plate such as mylar thin layer and polyethyleneterephthalate film. When a supporting plate is used as the substrate, a dried coating film can be detached from the plate to be applied on an electrode in a pre-lamination manner. The drying process may be performed at a temperature ranging from 25 to 80° C., preferably by passing a 50° C. air flow. The plasticizer-removal process may be conducted, e.g., by vacuum-drying at a temperature ranging from 20 to 150° C. under a pressure of 700 to 10⁻³ torr, preferably around 10⁻² torr. When the temperature and the pressure are out of the above ranges, the dry efficiency may become poor.

Exemplary lithium salts that may be used in the present invention are LiClO₄, LiBF₄, LiPF₆, LiCF₃SO₃, LiN(CF₃SO₂)₂ and a mixture thereof. The lithium salt may be present in the composition in an amount ranging from 0.1 to 20 parts by weight based on 100 parts by weight of a vinylidenefluoride(VdF)-hexafluoropropylene(HFP) copolymer. When the amount of the salt is less than 0.1 part by weight, no significant impedence reduction may be achieved; and when it is more than 20 parts by weight, the excess amount of the lithium salt may cause undesirable effects on the formed electrolyte precursor film.

The VdF-HFP copolymer used in the present invention may contain HFP in an amount ranging from 0.1 to 8% by weight. When the content of HFP in the copolymer is less than 0.1% by weight, it is difficult to dissolve the copolymer in a solvent; and when it is more than 8% by weight, poor mechanical property may result at the vacuum-drying step for removal of the plasticizer.

Representative examples of the plasticizer which may be used in the present invention include propylene carbonate, ethylene carbonate, butylene carbonate and gamma-butyrolactone. The plasticizer may be present in the composition in an amount ranging from 100 to 300 parts by weight based on 100 parts by weight of the VdF-HFP copolymer. When the amount of the plasticizer is less than 100 parts by weight, a polymer electrolyte having poor ionic conductivity may be formed; and when it is more than 300 parts by weight, the polymer electrolyte precursor film so formed may have a poor impact resistance.

Representative examples of the organic solvent which may be used in the present invention include acetone, methyl ethyl ketone and tetrahydrofuran. The organic solvent may be present in the composition in an amount ranging from 500 to 2000 parts by weight based on 100 parts by weight of the VdF-HFP copolymer. When the amount of the solvent deviates from the above range, coating property of the composition may become poor.

In addition, in order to enhance mechanical strength, the composition may further comprise a filler such as silica, kaolin and titanium dioxide in an amount of 10 to 150 parts by weight based on 100 parts by weight of the VdF-HFP copolymer. When the amount of the filler is more than 150 parts by weight, the formed polymer electrolyte precursor film may become too brittle.

In accordance with a further aspect of the present invention, there is provided a polymer battery comprising a cathode, an anode, and a polymer electrolyte interposed between the cathode and the anode, which comprises said polymer electrolyte precursor and a liquid electrolyte.

The dried polymer coating film may be inserted between the cathode and the anode sheets to form an electrode stack of a bicell type, wherein the coating composition may be directly coated on an anode, or laminated in the form of a film on a cathode, and the anode sheet is laminated on the coating film. The plasticizer of the electrode stack is removed, e.g., by vacuum-drying to form a polymer electrolyte precursor therein. The resulting stack is placed into a battery case and sealed, followed by injecting a liquid electrolyte thereinto, to prepare a bellcore-type polymer battery comprising the polymer electrolyte containing the polymer electrolyte precursor and the liquid electrolyte.

Typically, a cathode composition, i.e., a mixture of a cathode active material, a conducting agent, a binder and a solvent, may be coated directly on an aluminum current collector, or laminated in the form of a film on an aluminum current collector to form a cathode sheet.

The cathode active material may be lithium-containing metal oxides such as LiCoO₂, LiMnₓO₂ₓ and LiNiₓMn₂₋ₓO₄ (wherein x is 1 or 2). The conducting agent may be carbon black; the binder may be vinylidene fluoride/hexafluoropropylene copolymers, polyvinylidene fluoride, polyacrylonitrile, polymethylmethacrylate or polytetrafluoroethylene; and the solvent may be N-methylpyrrolidone or acetone. The conducting agent, the binder and the solvent may be used in amounts ranging from 1 to 10 parts by weight, from 2 to 10 parts by weight, and from 30 to 100 parts by weight, respectively, based on 100 parts by weight of the cathode active material.

Also, an anode composition, i.e., a mixture of an anode active material, a conducting agent, a binder and a solvent, may be coated directly on a copper current collector, or laminated in the form of a film on a copper current collector to form an anode sheet.

Representative examples of the anode active material may include lithium metals, lithium alloys, carbon-based materials and graphite. The conducting agent, the binder and the solvent, which may be the same as those used in the cathode composition, may be used in amounts of below 10 parts by weight, ranging from 2 to 10 parts by weight, and from 30 to 100 parts by weight, respectively, based on 100 parts by weight of the anode active material. If necessary, a plasticizer may be further added to said cathode and anode compositions to form porous electrode sheets.

A liquid electrolyte that may be used in the present invention comprises a lithium salt and an organic solvent. The lithium salt, which may be the same as those used in a polymer electrolyte precursor, may be present at a concentration in the range of 0.5 to 2.0M in the electrolyte. When the concentration of the salt is less than 0.5M, the capacity may become poor; and when it is more than 2.0M, the cycle life may become poor. Representative examples of the organic solvent include propylene carbonate, ethylene carbonate, diethyl carbonate, dimethyl carbonate, ethylmethyl carbonate, dipropyl carbonate, dimethyl sulfoxide, acetonitrile, dimethoxyethane, diethoxyethane, vinylene carbonate, gamma-butyrolactone, ethylene sulfite, propylene sulfite and tetrahydrofuran.

The following Examples and Comparative Examples are given for the purpose of illustration only, and are not intended to limit the scope of the invention.

### EXAMPLE 1

88 g of LiCoO₂, 6.8 g of carbon black, 5.2 g of polyvinylidene fluoride and 52.5 g of N-methylpyrrolidone were mixed to form a cathode composition, which was coated on an aluminum foil and dried to prepare a cathode sheet.

93.76 g of mesocarbon microbeads(MCMB), 6.24 g of polyvinylidene fluoride and 57.5 g of N-methylpyrrolidone were mixed to form an anode composition. This anode composition was coated on a copper foil and dried to prepare an anode sheet.

22.2 g of 94:6 VdF-HFP copolymer (Solvay 20615), 22.2 g of silica (Aldrich), 55.6 g of propylene carbonate (Mitsubishi Chem. Co.), 0.67 g of LiBF₄ and 220 g of acetone were mixed to form a composition for forming a polymer electrolyte precursor. This composition was coated on a polyethylene terephthalate(PET) film, dried for 1 minute under a 50° C. air flow and the resulting film was wound into a roll.

The above anode and cathode sheets were cut to predetermined sizes, the coated PET film was unwound, and the dried coating film was pre-laminated on both sides of the cathode sheet. Then, the cathode sheet with the two laminated films was placed on the anode sheet. Such bicells and anode sheets were alternately stacked, to form an electrode stack of a bicell type having the anode sheet on the highest side. The electrode stack was vacuum-dried at 100° C. under 1×10⁻² torr for one day to remove the plasticizer. The resulting stack was placed into an aluminum can and sealed, followed by injecting a liquid electrolyte (Merck, 1M LiPF₆ in a 1:1:1 volume mixture of ethylene carbonate, dimethyl carbonate and diethyl carbonate(EC/DMC/DEC)) thereinto, to obtain a polymer battery. Then, the battery was pressed at 100° C. with the force of 700 kg for 10 seconds.

### EXAMPLES 2 and 3

The procedure of Example 1 was repeated except that the amount of LiBF₄ used in the preparation of the polymer electrolyte precursor composition was 2.22 g and 3.33 g, respectively, to obtain two additional polymer batteries.

### COMPARATIVE EXAMPLE

The procedure of Example 1 was repeated except that LiBF₄ was not employed in the polymer electrolyte precursor composition, to obtain a comparative polymer battery.

### BATTERY PERFORMANCE CHARACTERISTICS

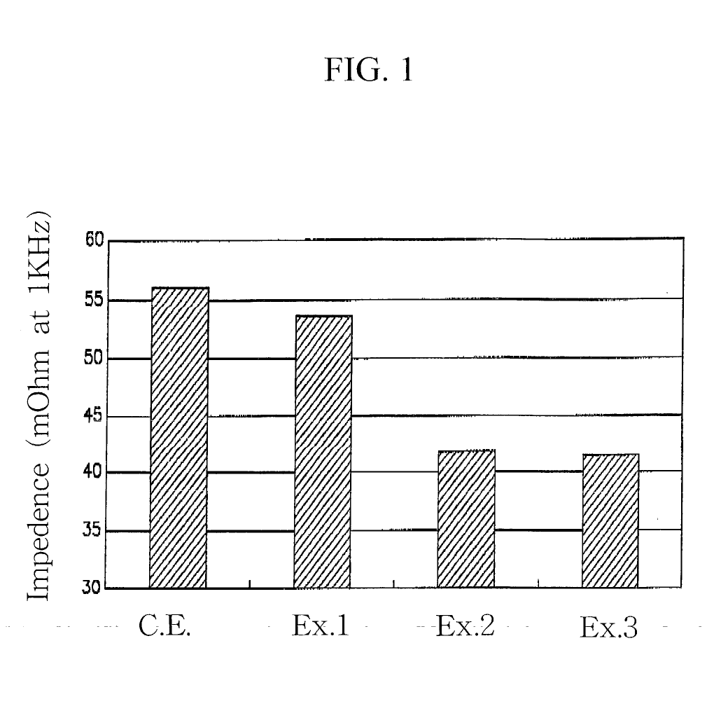

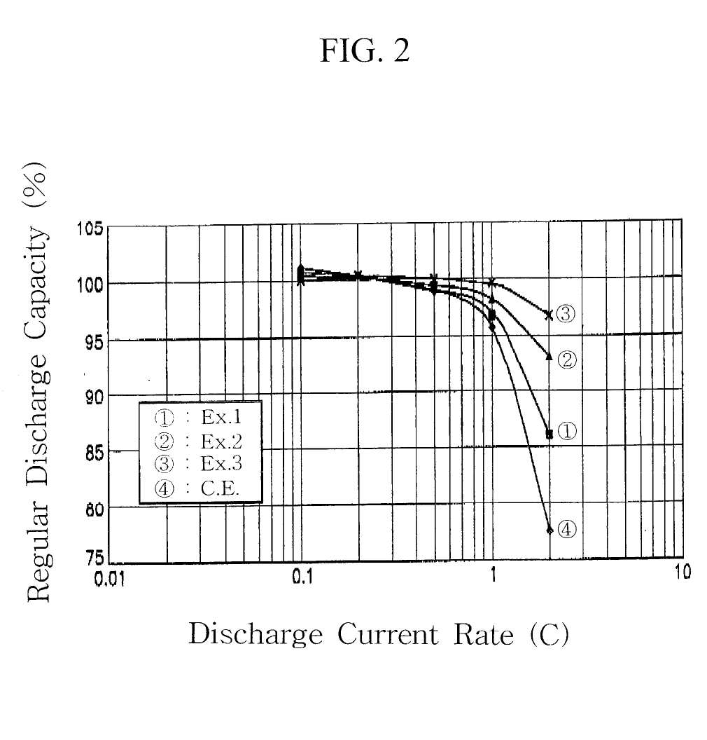

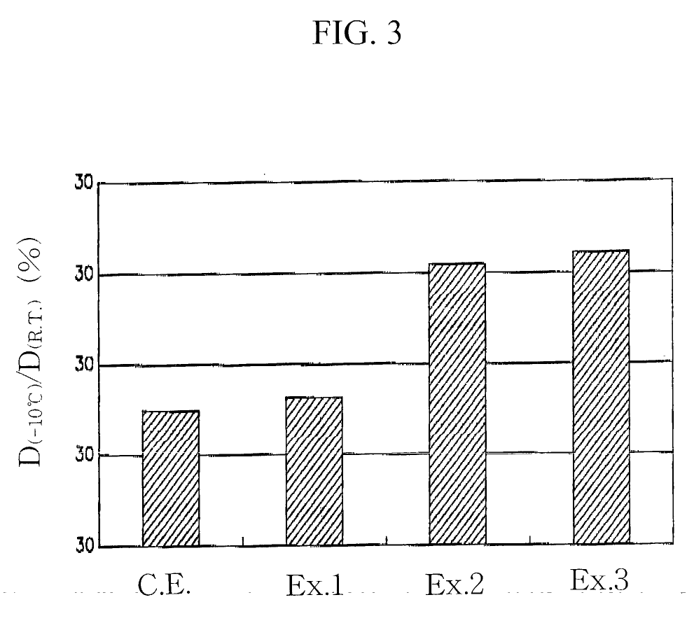

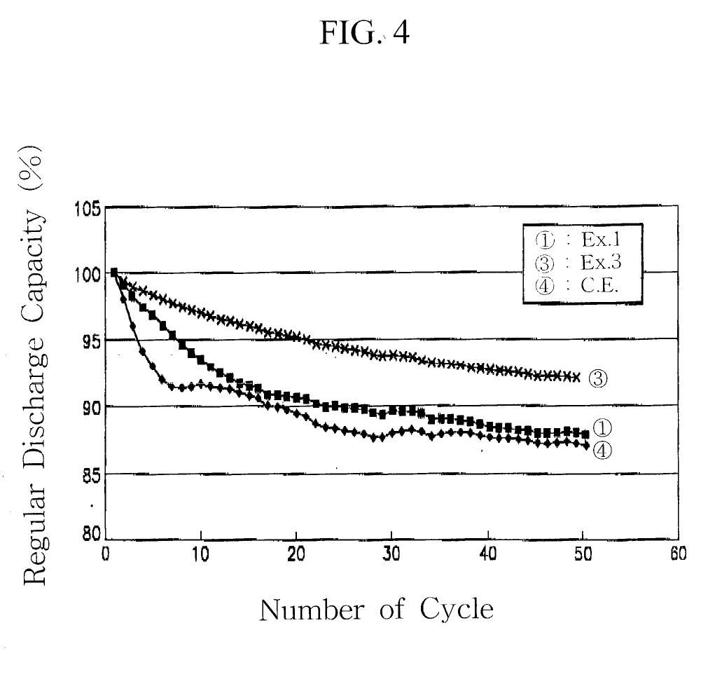

Impedence values(mOhm) at 1 KHz, variations of regular discharge capacity(%) with respect to discharge rate(C), low-temperature property values(capacity at −10° C./capacity at room temperature, %) at 1C discharge rate, and variations of regular discharge capacity(%) with respect to number of cycle were measured for the lithium polymer batteries obtained in Examples and Comparative Example, and the results are shown in FIGS. 1, 2, 3 and 4, respectively.

The batteries obtained in Examples 1, 2 and 3 exhibit much improved properties in terms of impedence, self-discharge, low-temperature characteristics and cycle life, as compared with the battery obtained in Comparative Example

Therefore, the inventive polymer electrolyte precursor may be advantageously used in preparing an improved bellcore-type polymer battery.

While the invention has been described with respect to the above specific embodiments, it should be recognized that various modifications and changes may be made to the invention by those skilled in the art which also fall within the scope of the invention as defined by the appended claims.

What is claimed is:

1. A polymer electrolyte precursor for a polymer battery, which comprises a vinylidenefluoride(VdF)-hexafluoropropylene(HFP) copolymer having an HFP content of 0.1 to 8% by weight, a lithium salt and a plasticizer.

2. The polymer electrolyte precursor of claim 1, wherein the amount of the lithium salt is in the range of 0.1 to 20 parts by weight based on 100 parts by weight of the VdF-HFP copolymer.

3. A process of preparing a polymer electrolyte precursor for use in a polymer battery, which comprises the steps of coating and drying a composition comprising a VdF-HFP copolymer, a lithium salt, a plasticizer and an organic solvent on a substrate, and then removing a portion of the plasticizer from the coated composition.

4. The process of claim 3, wherein the drying step is conducted at a temperature ranging from 25 to 80° C.

5. The process of claim 3, wherein the plasticizer-removal step is performed by vacuum-drying at a temperature ranging from 20 to 150° C. under a pressure of 700 to 10⁻³ torr.

6. The process of claim 3, wherein the composition comprises the lithium salt, the plasticizer and the organic solvent in an amount ranging from 0.1 to 20 parts by weight, 100 to 300 parts by weight and 500 to 2000 parts by weight, respectively, based on 100 parts by weight of the VdF-HFP copolymer.

7. The process of claim 3, wherein the lithium salt is selected from the group consisting of LiClO₄, LiBF₄, LiPF₆, LiCF₃SO₃ and LiN(CF₃SO₂)₂.

8. The process of claim 3, wherein the plasticizer is selected from the group consisting of propylene carbonate, ethylene carbonate, butylene carbonate and gamma-butyrolactone.

9. The process of claim 3, wherein the organic solvent is selected from the group consisting of acetone, methyl ethyl ketone and tetrahydrofuran.

10. The process of claim 3, which the composition further comprises a filler in an amount ranging from 10 to 150 parts by weight based on 100 parts by weight of the VdF-HFP copolymer.

11. The process of claim 10, wherein the filler is selected from the group consisting of silica, kaolin and titanium dioxide.

12. A polymer battery comprising a cathode, an anode, and a polymer electrolyte interposed between the cathode and the anode, which comprises the polymer electrolyte precursor of claim 1 and a liquid electrolyte.

13. The battery of claim 12, wherein the liquid electrolyte comprises a lithium salt and an organic solvent.

14. The battery of claim 13, wherein the lithium salt is selected from the group consisting of LiClO₄, LiBF₄, LiPF₆, LiCF₃SO₃ and LiN(CF₃SO₂)₂.

15. The battery of claim 13, wherein the organic solvent is selected from the group consisting of propylene carbonate, ethylene carbonate, diethyl carbonate, dimethyl carbonate, ethylmethyl carbonate, dipropyl carbonate, dimethyl sulfoxide, acetonitrile, dimethoxyethane, diethoxyethane, vinylene carbonate, gamma-butyrolactone, ethylene sulfite, propylene sulfite and tetrahydrofuran.
